(19) United States
(12) Patent Application Publication
(10) Pub. No.: US 2026/0195696 A1
(43) Pub. Date: Jul. 9, 2026

(54) ADAPTIVE ORGANIZATIONAL MATURITY PLATFORM HAVING DYNAMIC CONFIGURATIONS ACCORDING TO ORGANIZATIONAL PROGRESS

(71) Applicant: Polarisoft LLC, Dover, DE (US)

(72) Inventors: Stephen Brown, Hilton Head Island, SC (US); William Speegle, Savannah, GA (US); Shaun McCormack, Teddington TW11 0DG (GB)

(73) Assignee: Polarisoft LLC, Dover, DE (US)

(21) Appl. No.: 19/439,723

(22) Filed: Jan. 5, 2026

Related U.S. Application Data
(60) Provisional application No. 63/742,402, filed on Jan. 6, 2025.

(51) Int. Cl. G06Q 10/067

(52) U.S. Cl. CPC G06Q 10/067

(57) ABSTRACT

A computer system for organizational maturity and competency development comprising: a processor; memory; computer-readable instructions that cause the system to: receive a dataset concerning organizational goals; generate a maturity acceleration plan (MAP) with maturity metrics for entities; generate performance acceleration models (PAMs) based on the MAP, each PAM can include measurement criteria representing knowledge, competence, and proficiency; store a hierarchical data structure with MAP at first level, PAMs at second level, and accolades at third level; monitor user interactions detecting accolade completion by tracking training course completion, platform feature usage, data element creation, data enrichment, and specified actions; display a visual dashboard showing organizational maturity progress, deployed MAPs, and completed PAMs. The system can provide an AI algorithm with pre-defined parameters and organization rules to suggest additional aspects of the maturity acceleration plan and utilizes the AI algorithm to provide a new or modified maturity acceleration plan.

### RELATED APPLICATIONS

This application claims priority to U.S. Provisional Patent Application No. 63/742,402, titled ADAPTIVE MATURITY PLATFORM FOR ORGANIZATIONAL ASSESSMENT, filed 01/06/2025, which is hereby incorporated by reference in its entirety.

### BACKGROUND OF THE INVENTION

### Field of Invention

This system is an adaptive maturity platform that dynamically configures and implements organizational maturity models using artificial intelligence to automatically align technology capabilities with evolving organizational needs, organizational progress and changing user competencies.

### Description of the Related Art

Organizations today face increasingly complex challenges in managing their business processes, developing employee skills, and achieving strategic objectives. Traditional approaches to software implementation and training often fall short in addressing these dynamic needs. While many companies invest in various software platforms and training programs, these solutions frequently suffer from a lack of adaptability and alignment with organizational goals. The rapid pace of technological change and evolving business landscapes demand more flexible and responsive systems. Static software configurations and one-size-fits-all training programs quickly become outdated, leading to inefficiencies and missed opportunities for growth. Additionally, organizations struggle to accurately assess their current capabilities, identify areas for improvement, and measure progress towards maturity in critical business processes.

Furthermore, the disconnect between individual employee development and broader organizational objectives can hinder overall performance. Many existing systems fail to create a cohesive link between personal skill advancement and the achievement of company-wide goals. This misalignment can result in wasted resources, reduced employee engagement, and slower organizational progress. Another challenge lies in the ability to capture and leverage data effectively. While companies may collect vast amounts of information about their operations and workforce, they often lack the tools to transform this data into actionable insights. The potential for using artificial intelligence and machine learning to drive continuous improvement remains largely untapped in many organizational contexts.

There is a growing need for integrated platforms that can adapt to the unique needs of each organization, provide targeted development opportunities for employees, and offer data-driven insights to guide strategic decision-making. Such systems could potentially bridge the gap between individual growth and organizational maturity, leading to more efficient and effective business operations. As organizations continue to seek ways to enhance their competitiveness and agility, the development of more sophisticated, adaptive, and intelligent management and training solutions becomes increasingly important. Addressing these challenges could unlock new possibilities for organizational growth, employee development, and overall business success.

Traditionally, software, including training software, has either been developed from scratch or configured using a platform that provides low code or codeless configuration. Generally, the process is a structured process that involves several stages to create, design, deploy, and support software. The stages can include planning and requirement analysis that is an initial phase which includes understanding what the software functionality and application is and gathering requirements from stakeholders. This process required human interaction between stake holders and the developers. Another stage can be the design phase where the software's architecture is determined. This stage can include defining the overall system architecture, user interfaces, and data models that can result in a blueprint for the development team to use. Another stage can be the implementation stage or coding. Developers write the human readable instructions that can be complied into machine readable instructions resulting in the software application. This stage is often iterative, with human developers writing code, testing it, and refining it as needed with input from the client, customer or other stakeholders. Another stage is testing where the developed code is tested to ensure it works as design and expected. This stage can include unit testing, integration testing, system testing, and acceptance testing. The goal is to identify and fix any bugs or issues prior to widespread release. Another stage can be deployment, which is the stage when the software is released to a production environment and provided to end-users. After release, there can be a maintenance stage where that includes updates, and adding new features as needed. Maintenance can include bug fixes and seeks to ensures that the software continues to meet user needs over time. There is also a stage that can include review and feedback from users and other stakeholders that is used to improve the software. This feedback can be used to make iterative improvements and ensure the software remains relevant and useful.

### BRIEF SUMMARY OF THE INVENTION

The above objectives are accomplished by providing a computerized system for dynamically configuring and implementing a maturity model is provided. The system is adapted to receive a dataset concerning an aspiration associated with an organization goal or skill including a survey, a goal and a set of historical organization information. The system generates a maturity acceleration plan according to the dataset. The system analyzes the dataset to identify key progress and status of maturity of the user and organization. The system provides an artificially intelligent algorithm with pre-defined parameters and organization rules to suggest additional aspects of the maturity acceleration plan and utilizes the artificially intelligent algorithm to provide a new or modified maturity acceleration plan. The system provides the new or modified maturity acceleration plan to a user.

According to other aspects of the present disclosure, the computerized system may include one or more of the following features. Generating the dataset may include retrieving data from a third-party dataset using natural language processing to extract attributes from the third-party dataset. Generating a maturity acceleration plan may be according to a collection of maturity metrics applicable to at least one of: an individual, a team, a department, or an entire organization. The system may include generating a performance acceleration model (PAM) for an individual based on the MAP, the PAM comprising a collection of measurement criteria representing the individual's ability to demonstrate knowledge, competence, and proficiency in a specified area.

According to another aspect of the present disclosure, a method for implementing an adaptive maturity platform is provided. The method includes defining an aspiration for an organization, performing a multi-level maturity assessment according to the aspiration, deploying a maturity acceleration plan (MAP) based on results of the maturity assessment, monitoring user interactions with the adaptive maturity platform, updating the MAP based on the monitored user interactions, and automatically unlocking platform features based on completion of the MAP.

According to other aspects of the present disclosure, the method may include one or more of the following features. The method may include conducting surveys with individuals at multiple levels of the organization to gather perceptions of organizational abilities in specific organization practices. The method may include selecting a pre-configured MAP from a library of MAPs based on the results of the maturity assessment. The method may include utilizing an artificial intelligence algorithm to match individuals with appropriate PAMs based on their roles and previous interactions with the platform. The method may include tracking completion of accolades associated with each PAM, wherein accolades represent individual measurements of user progress. The method may include analyzing completed accolades and PAMs to determine overall progress towards MAP completion. The method may include granting access to new functionalities or tools within the adaptive maturity platform based on achieving specific completion levels within the MAP.

According to another aspect of the present disclosure, a computerized system for dynamically configuring a training platform is provided. The system includes generating a library of pre-configured maturity acceleration plans (MAPs), receiving user interaction data from a plurality of users engaging with the training platform, analyzing the user interaction data using artificial intelligence to identify areas of misalignment between user competencies and organizational goals, creating or selecting a MAP from the library based on the identified areas of misalignment, deploying the MAP to a group of users, and dynamically adjusting the deployed MAP based on ongoing user interactions and performance metrics.

According to other aspects of the present disclosure, the system may include one or more of the following features. The system may include generating performance acceleration models (PAMs) associated with the selected MAP, each PAM comprising a collection of measurement criteria for assessing individual user competencies. The system may include assigning PAMs to individual users within the group based on their roles and previous interactions with the training platform. The system may include tracking completion of accolades associated with each PAM, wherein accolades represent individual measurements of user progress. The system may include dynamically adjusting the deployed MAP by analyzing completed accolades and PAMs to determine overall progress towards MAP completion. The system may include automatically unlocking additional platform features based on the performance and analysis of the user according to the MAP and/or PAM.

According to another aspect of the present disclosure, a computerized system for dynamically configuring a training platform is provided. The system includes a library of pre-configured maturity acceleration plans (MAPs) and a computerized system adapted to deploy the MAP to a group of users, receive user interaction data from a plurality of users engaging with the training platform, analyze the user interaction data using artificial intelligence to identify areas of misalignment between user competencies and organizational goals, dynamically adjust the deployed MAP based on ongoing user interactions and performance metrics, track completion of accolades associated with performance acceleration models (PAMs), wherein accolades represent individual measurements of user progress, analyze completed accolades and PAMs to determine overall progress towards MAP completion, and automatically unlock additional platform features based on achieving specific completion levels within the MAP.

According to other aspects of the present disclosure, the computerized system may include one or more of the following features. The system may be adapted to capture anonymized benchmark meta data about time, number of people, and target rates upon completion of a MAP, and use the anonymized benchmark meta data for comparisons with other organizations' progress against MAPs and organizational objectives. The system may be adapted to utilize machine learning techniques to analyze user interaction data as training data, generate predictive insights for future plans based on historic data, and suggest success rates for a given plan based on the predictive insights.

### BRIEF DESCRIPTION OF THE SEVERAL VIEWS OF THE DRAWINGS

The construction designed to carry out the invention will hereinafter be described, together with other features thereof. The invention will be more readily understood from a reading of the following specification and by reference to the accompanying drawings forming a part thereof, wherein an example of the invention is shown and wherein:

FIG. 1 is a flowchart of aspects of the computerized system;

FIG. 2 is a diagram of aspects of the computerized system; and,

FIG. 3 is a block diagram of aspects of the computerized system.

While each of the drawing figures depicts a particular embodiment for purposes of depicting a clear example, other embodiments may omit, add to, reorder, and/or modify any of the elements shown in the drawing figures. For purposes of depicting clear examples, one or more figures may be described with reference to one or more other figures, but using the particular arrangement depicted in the one or more other figures is not required in other embodiments. The drawings and schematic representations are intended to support the understanding of the invention. These may not be to scale and are not intended to limit the invention to any particular layout, connectivity, or architectural implementation. Correspondence between drawing elements and described components is provided for illustrative purposes and should not be interpreted to limit the claim scope.

### DETAILED DESCRIPTION OF THE INVENTION

In the following description, for the purposes of explanation, numerous specific details are set forth in order to provide a thorough understanding of the present disclosure. It will be apparent, however, that the present disclosure may be practiced without these specific details. In other instances, well-known structures and devices are shown in block diagram form in order to avoid unnecessarily obscuring the present disclosure. Modifiers such as “first” and “second” may be used to differentiate elements, but the modifiers do not necessarily indicate any particular order. With reference to the drawings, the invention will now be described in more detail.

This system is novel in its approach to organizational maturity development through dynamic software platform configuration. Unlike existing training and software systems that focus primarily on individual learning or skill development, this system addresses organizational maturity and competency development as a holistic process that encompasses teams, departments, and entire organizations. The system may automatically configure and reconfigure the software platform itself based on organizational maturity progress, eliminating the need for traditional software development cycles or manual reconfiguration by developers.

The system creates alignment between three components that are traditionally misaligned in organizational contexts: users (employees), technology capabilities, and organizational goals. Conventional software implementations and training programs often suffer from disconnects between these elements, where employee development may not align with organizational objectives, or where technology capabilities may not match the current needs of the workforce. This system addresses these misalignments through continuous monitoring and adaptive configuration.

The system captures anonymized benchmark metadata including time, number of people, and target rates upon completion of maturity acceleration plans. This metadata may be used to compare organizational maturity progress across different organizations, providing insights that were previously unavailable in traditional software or training platforms. The benchmarking capability allows organizations to understand their progress relative to peers without compromising confidential information.

The system may reduce or eliminate human bias in software configuration and organizational alignment. Traditional software development and configuration processes rely heavily on human judgment and interpretation, which can introduce systematic biases in how technology is deployed and how organizational capabilities are assessed. By utilizing artificial intelligence algorithms with predefined parameters and organization rules, the system provides data-driven recommendations and configurations that may minimize the impact of subjective human biases on organizational development and technology deployment decisions.

The system can include a computerized system for dynamically configuring and implementing a maturity model receives a dataset concerning an organizational aspiration, including a survey, goal, and historical information. The system can generate a maturity acceleration plan (MAP) according to the dataset, analyzes it to identify progress and maturity status, and utilizes an artificially intelligent algorithm with predefined parameters and rules to suggest additional aspects or modifications to the MAP. The system deploys the MAP to users, monitors interactions, and dynamically adjusts the MAP based on ongoing user performance. Performance acceleration models (PAMs) are assigned to individuals, with progress tracked through completion of accolades. The system analyzes completed accolades and PAMs to determine overall progress, automatically unlocking additional platform features upon achieving specific completion levels within the MAP.

The present computerized system provides a software platform for configuring organization applications without the need for the traditional software development process. This computerized system uses subsystems that learn from an organization's engagement with data, users (individuals) and organization processes to provide an enterprise platform for adaptive learning and performance management.

The system includes computer readable instructions that provide constant measurement of organizational readiness for each user and each organization process being managed. The system compares the organization process with benchmark data obtained from users and organizations to identify the readiness of that organization or user for higher levels of organization maturity in the target process. For each area (e.g., process) being monitored, the system determines what criteria need to be met for the current maturity acceleration plan (MAP). The MAP accelerates growth and maturity in certain areas of the organization through a series of steps and activities aimed at assessing the current competence level, identifying areas for improvement, and implementing targeted actions to achieve higher levels of competence. The MAP includes assessment of the current maturity level by evaluating various aspects such as processes, technology, and organizational capabilities. According to this assessment, specific goals are set to achieve higher levels of competence, aligned with the organization's overall strategy and objectives. A roadmap is developed to outline the steps and activities required to achieve the set goals, including timelines, milestones, and resource allocations. The system assists an organization in tracking and managing its performance by utilizing key performance indicators (KPIs) such as acquisition costs, customer retention, conversion rates, employee retention, sales growth, software usage, user actions, task and analysis, gross margin and other performance indicators to assess the success of their strategies and ensure alignment with their overall objectives.

The system monitors and evaluates the organization to identify any deviations from the roadmap, allowing for necessary adjustments to processes and training to stay on track. This dynamic roadmap continuously evolves through regular reviews and updates, allowing the organization to improve its competence levels and achieve continued maturity. User participation in training courses and consistent interaction with the system's data and processes over time leads to dynamic improvement of the organization and increased maturity.

To promote an aggregate view of a team, department or whole organization, the system provides individual human interactions using a Performance Acceleration Model (PAM). An individual may have any number of PAMs applied to them, creating a clear path for that individual to gain organization awareness and maturity and demonstrate their knowledge and expertise within a given process or domain. When an organization first begins implementing an AMP, it may not have enough interaction data to allow for the machine learning component (AI) to recommend where the user is in relation to the available MAPs. Organizations may start with survey-based maturity assessments by surveying many individuals at many levels in the organization to create a starting data set that shows perceived areas of alignment and misalignment. The AI uses the meta data from the PAMs, MAPs, benchmarking, user interactions, and maturity assessments to constantly monitor and identify areas where maturity gains are possible and where maturity has slipped. This provides a dynamic feedback loop of interactions, information and improvements that furthers the maturity of the organization. The results of the user (e.g., gains and losses) become triggers to open new tools and features on the software system or open the next MAP allowing the user to move to the next level of access, thereby aligning the organization's users, technology and data, and organization goals.

Assessments are driven by the organization's strategic objectives recorded in the system. The assessment includes a survey based on desired organization functions or domains aligned to the aspirations. Each assessment is a series of questions that gather from the individual taking the survey their perception of the organization's abilities in a specific organization practice. These assessments are completed by individuals at many levels in the organization to highlight where perceptions of the organization differ.

Human bias is generally a systematic pattern of deviation from norm or rationality in judgment, often leading to inaccurate or irrational decisions. Biases can be conscious (explicit) or unconscious (implicit), and they affect how we perceive, interpret, and respond to information. Reducing or eliminating the impact of human bias can improve a company and assist with aligning the users, technology and goals of the organization.

The AMP gathers meta data from users and their interactions with the system where the interaction is used by the AI to build organization maturity profiles resulting in the ability to automatically align technology with the needs of the organization without reconfiguration or development.

The system includes solution templates that provide a preconfigured starting point for the organization and users. Users can use the template without modification or can adjust the configuration according to the organization needs. Preexisting templates can include corporate performance management or KPI tracking, project and portfolio management, professional services automation, new product development and governance, risk and compliance.

The corporate performance management template assists organizations with furthering organizational strategies through data analysis, prescribed methodologies, reporting, and processing to track and manage the organization's performance. It offers an integrated approach to budgeting, forecasting, and organization planning for various departments such as finance, marketing, sales, and human resources. This template includes metrics such as key performance indicators (KPIs) that assist the organization with assessing the success of their strategies, including acquisition costs, customer retention, conversion rates, employee retention, sales growth, and gross margin. The template assists with processes carried out by the organization and evaluates how it handles its production activities, organization practices, and employees, helping to identify areas for improvement and ensuring that processes are efficient and effective. The template assists with strategies that include methodologies that an organization's leaders can use to define their management tactics, including setting goals, developing plans to achieve those goals, and aligning the organization's activities with its strategic objectives. This template assists an organization to comprehensively analyze their goals, operations, successes, and setbacks, thereby enhancing the function of multiple organization areas, improving their financial health, and ensuring that their strategies are aligned with their overall objectives.

The most common maturity metric is the measuring of individual end user engagement and progression via a PAM. When deploying a MAP, a particular team, department, division, or unit, group of people is selected. Based on role-based PAMs within the MAP a sub-group of individuals will be assigned to each PAM. Some individuals may have multiple PAMs.

The project and portfolio management template assists with a strategic approach to manage and optimize projects and programs. It involves the centralized management of multiple projects and programs to ensure they align with the organization's strategic goals and objectives. The template assists with project proposals and selecting processes so that those are chosen that align with the strategic goals of the organization, better distributing resources (such as budget, personnel, and equipment) across projects to ensure optimal utilization and avoid conflicts, tracking the progress of projects and programs to ensure they are on track to meet their objectives by monitoring key performance indicators (KPIs) and adjusting as needed, and identifying, assessing, and mitigating risks that could impact the success of projects and the overall portfolio.

The professional service automation template integrates various functions such as project management, resource management, time tracking, billing, and reporting into an efficient software platform, helping organizations streamline their processes, improve productivity, and enhance overall service delivery.

The new product development template assists with product development stages including idea generation, idea vetting and screening, concept design and prototyping, organization and commercial case development and analysis, product development, marketing testing and commercialization.

The governance, risk and compliance template assist the organization with its ability to manage and comply with internal and external regulatory and operational guidelines.

The system's functionality improves upon existing competencies which, while properly implemented initially, have not grown or changed as the organization evolved. These preexisting competences can include flaws from human bias. The need for frequent reconfiguration, expensive reinvestment and the existing misalignment between the current competencies and the organization goals results in a significant hurdle to the organization to mature.

The system includes the ability to perform an initial assessment so that the domain of subsequent MAPs needs can be determined and specific areas developed for presentation to the user. The system includes a digital dashboard that tracks and displays the organization's competency and maturity over time. It displays the AI results for areas of misalignment and recommends MAPs, past and in-progress MAPs, and warning indicators to identify where competence and maturity losses might be occurring in the organization. From this dashboard the system provides recommended MAPs that can be deployed. The user can also respond to the information displayed by the dashboard and select a MAP from a MAP library. For past and in-progress MAPs, the user can drill down into the details of the information displayed on the dashboard and the MAP to see which users have performed against their respective PAMs.

The MAP includes a collection of maturity metrics that can be applied to an individual, team, department or whole organization. These metrics are created so that they represent and reflect the organization's knowledge and competency (e.g., maturity) in each organization's process or area. A specific metric value (e.g., "Completion Level") is identified to represent that the organization has reached a sufficient level to be ready for the next MAP. Reaching a Completion Level triggers a set of actions that can differ from MAP to MAP. The PAMs provide a collection of measurement criteria that represent the individual's ability to have demonstrated knowledge, competence and proficiency in a specified area. Measurements are captured using accolades. Accolades represent the individual measurements and can be of the following types: the user has taken a specific training course or participated in a specific training session, the user has used a specific feature, the user has created a specific data element, the user has enriched data to specific complexity, the user has constantly performed a specific task or action or some other metric that the organization wishes to measure. Some accolades have dependencies and include requirements (e.g., prerequisites) that must be completed in a certain order. As a user completes the criteria for a specific accolade on the system, they are notified, including if the completed criteria also results in a completed PAM. The specific task of completion may also result in the MAP being completed as well.

Once sufficient criteria for a MAP is completed, a series of actions are initiated. These actions can include: the assignment of a new MAP to the organization which may require the organization to create a new policy, process or standard, a new set of PAMs can be created and deployed to users, an AI suggested MAP can be provided and the system can automatically unlock additional of the systems features.

The system includes a set of pre-configured MAPs in a library. The MAPs, PAMs and accolades are configurable and can also be created outside of the library content. An AI analyst includes an artificial intelligence machine learning construct that learns from end users' interactions with data and highlights MAP opportunities, identifies risks, and areas where the organization is struggling to evolve, improve competence, and mature.

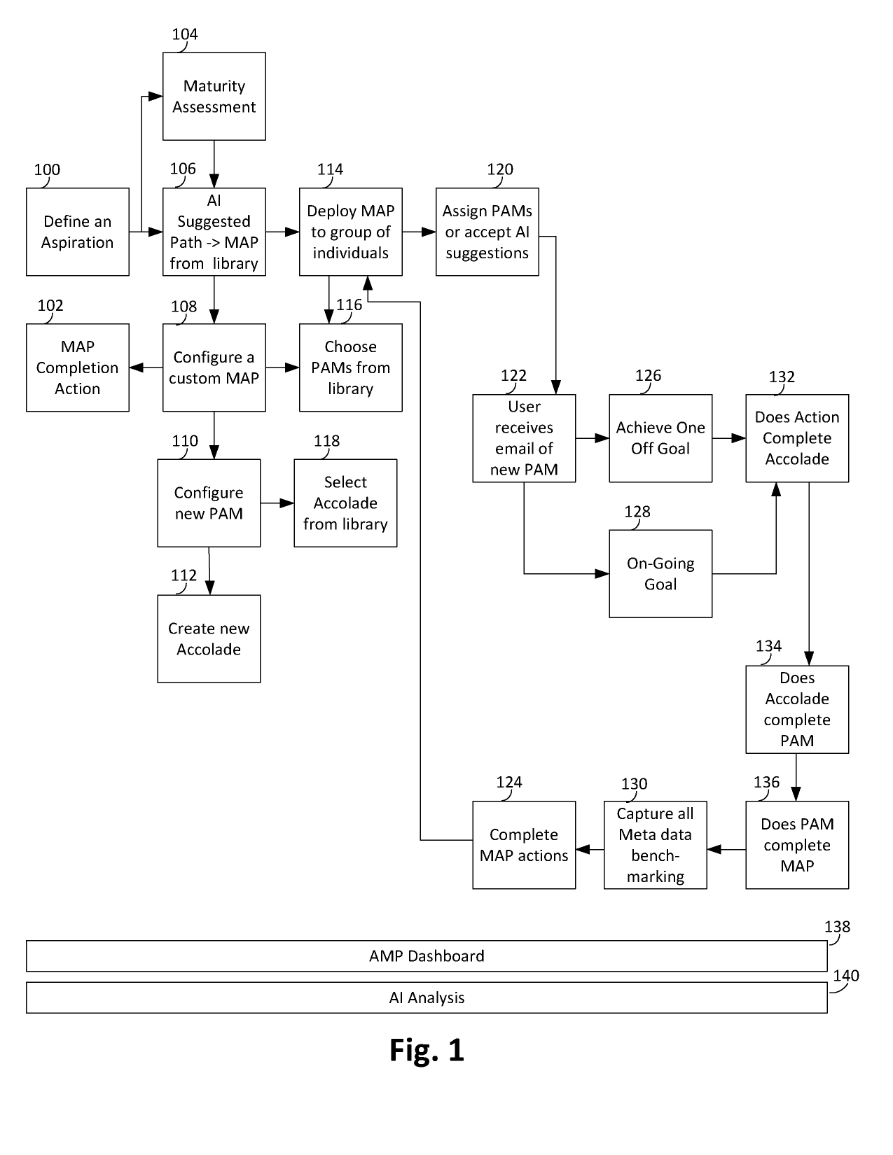

Referring to FIG. 1, the system defines an aspiration (e.g., goal) at 100. When defining an aspiration, a user decides on a strategic organization objective or set of organization objectives. The aspiration is entered into the system using basic text. The system presents content suggestions that are like that entered which also might represent that objective. For examples, the system can determine that "increase receipts" might be the same as "increase revenues."

The system performs a competency (e.g., maturity) assessment. This process creates data that is used to further train the AI engine. The administrative user selects an off-the-shelf maturity assessment to deploy to the end user community. Maturity assessments are deployed as a set of maturity questions that an end user responds to and provides values as a response. This process builds a data set available to the AI engine to help it suggest MAPs and compare with benchmark data.

The AI suggests a path for the user to travel through the MAPs from a library. Using machine learning, tree-walking, benchmark data, and predictive analytics, the AI engine provides possible paths through a series of MAPs to achieve their specific organization outcome, these MAPs are available from a library of templates. The end user can choose to use one of these paths or configure their own MAP from scratch.

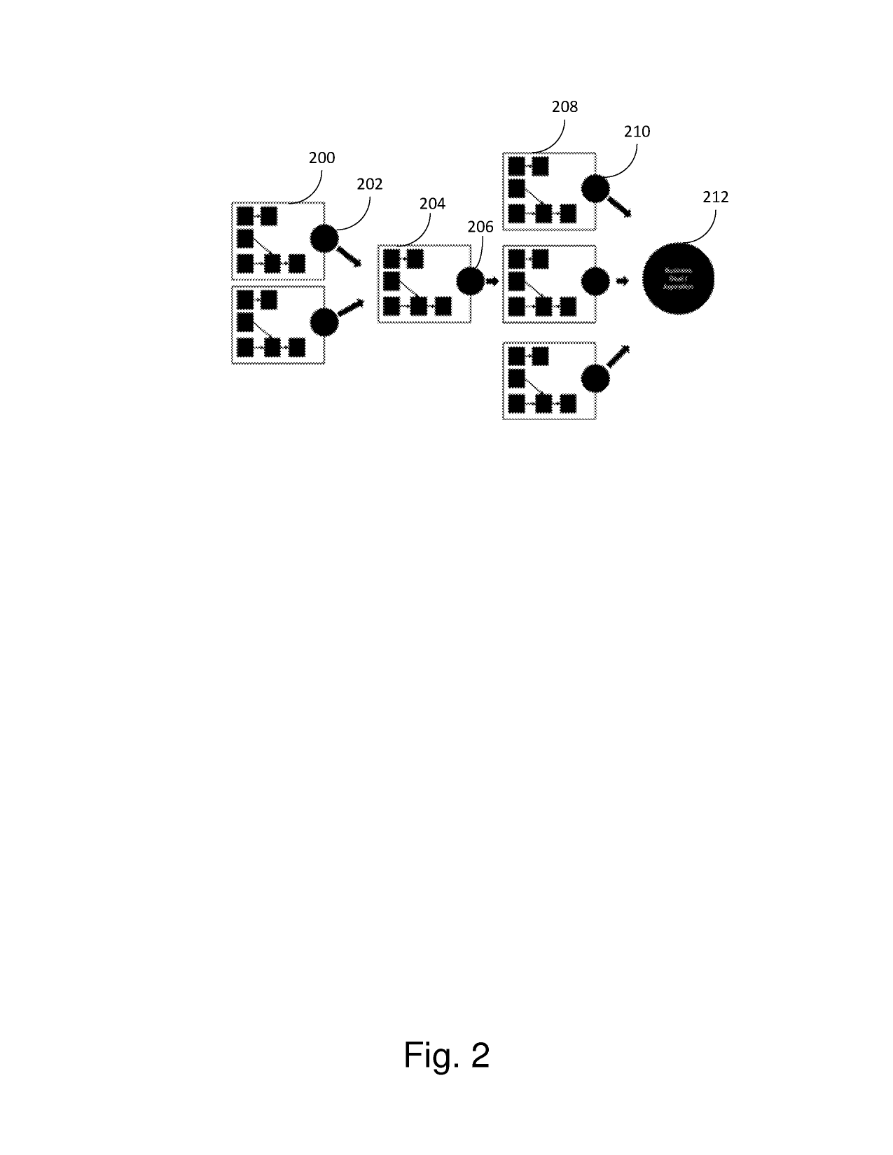

FIG. 2 represents a potential path through the MAPs. The user is initially given access to MAPs as 200 with a preliminary aspiration or goal 202. Upon reaching that goal, the system "unlocks" or allows access to another MAP 204 having another goal 206. According to the user, group or other criteria, the user is provided access to another MAP 208. Once goal 210 is reached, the overall goal of the organization 212 has been met.

If an appropriate MAP is not available in the MAP library, a MAP can be created. New MAPs are described as small steps for the improvement of organization competency or maturity that improve or further the objectives of the organization. Typically, several MAPs need to be created in succession to meet an objective. Each MAP is described in a series of PAMs to be achieved by a group of users (e.g., individuals) typically organized by their respective organization role. For example, the analysts need do task X and the managers need to do task Y. PAMs can either be selected from the library or can be created specifically for that organization. Each PAM is given a % completion target that will indicate the number of users that have to complete the PAM for the MAP to be considered complete. A MAP will typically require multiple PAMs to meet their targets for it to complete. Upon completion of a MAP, a set of actions will be triggered as shown in 102 of FIG. 1. PAMs may be used in multiple MAPs.

Each time a user completes an accolade, the system checks to see if that action was the last part required for completion of a PAM. If a PAM has been completed, the system checks all related MAPs to determine if a MAP has met all its PAM targets. If so, the system initiates a set of actions as shown in 112 of FIG. 1. When creating a MAP, action is defined that will be automatically triggered on completion. These actions include deploying another MAP to a group of users, which in turn will provide those users with additional accolade goals and training to complete and granting access to a new set of functionalities to a group of users. Completion is recognized and celebrated in the form of a digital announcement in the system that can include a congratulatory electronic message.

PAMs define a set of training, actions, and engagement to represent a user's evolution towards the organizations shared organization competency and maturity. PAMs are typically organized for organizational roles. PAMs use a selection of accolades to determine if they are complete and communicate to the end users the applicable goals. Unlike MAPs, all accolades need to be 100% complete for the PAM to complete the process. For example, if an organization wanted to improve their shareholder value, they might need to get their employees to understand financial capitalization so that they can improve their balance sheet. The organization may make a PAM for a MAP they have named "Financials – Level 1." That PAM might include multiple accolades to represent their teams' growth. The system provides an "Understanding Capitalization" training that includes the user creating a budget for next year that uses capital and having the user record the capital benefits for 12 months. This trains the user in this subject and increases the competency and maturity of the organization.

Accolades are mechanisms that allow for any individual interaction to be captured and tracked. These interactions are typically triggered by interaction within the system but can also be triggered from a 3rd party system. Accolades can be triggered or calculated. Events are typically triggered from things like "clicked on button", "added data", "completed training." Calculated accolades are data driven, for example, "raised 100 risks", "complete first 100k budget project." The accolades subsystem constantly monitors accolade events, and calculations.

Once a MAP is selected, it is deployed to a group of people in the organization. This selection can be automatic as shown in 124 of FIG. 1 or based on human interaction. Groups are organized by department, team, role, or any other designation of users. The same MAPs can be provided to multiple teams in the organization. Progress for such teams is track separately.

After selecting a MAP to be deployed to a group, the individuals within the group must be assigned to specific PAMs. This can be done manually. The AI analyst shown as 140 in FIG. 1, has access to all previous interactions the user has had with the system. Using machine learning techniques, the AI provides the appropriate PAM for each user within the MAP. Once a PAM has been assigned, users are notified. This allows the user to look at their PAM to understand what accolade goals they should seek to achieve.

In completing accolades, PAMs and MAPS, the provision of one-off goals can be provided. One off goal is an event driven accolades that complete when the goals is reached such as "taken training X." The user is notified of this achievement. There can also be on-going goals. These goals are target driven or time based and are typically configured using calculated accolades. These goals could be "complete your timesheet for 6 months straight" or "raise 30 organization risks".

During or after each user interaction the system checks to see if an accolade is complete. If an individual has completed an accolade the engine checks to see if that completion also completes a PAM. If a PAM completes related MAPs are checked to see if they meet the target threshold for each of the PAMs contained within. Once a MAP is complete, benchmark meta data is captured about time, number of people, target rates and the like. This data is anonymized so that it can be used for other customer comparisons. The completion of MAP action results in triggering as shown in 102 (FIG. 1).

The AMP dashboards provide visibility into the entire AMP framework. It shows deployed MAPs and provides a list of deployed MAPs and their progress. It shows a "league table" of top PAM achievers, and other data about the active environment. The system provides AI driven suggestions for future MAPs that the organization may wish to consider. The system provides comparisons against other organizations for progress against MAPs and Organization Objectives (e.g., benchmark information).

AI in the system provides analytical and generative capabilities. Using a neural network approach, the system uses the user interaction data as training data to allow the AI to help create and suggest MAPs and paths through MAPs. The system uses predictive analytics to take historic data and build predictive insights for future plans. This allows for the AI to suggest success rates for a given plan.

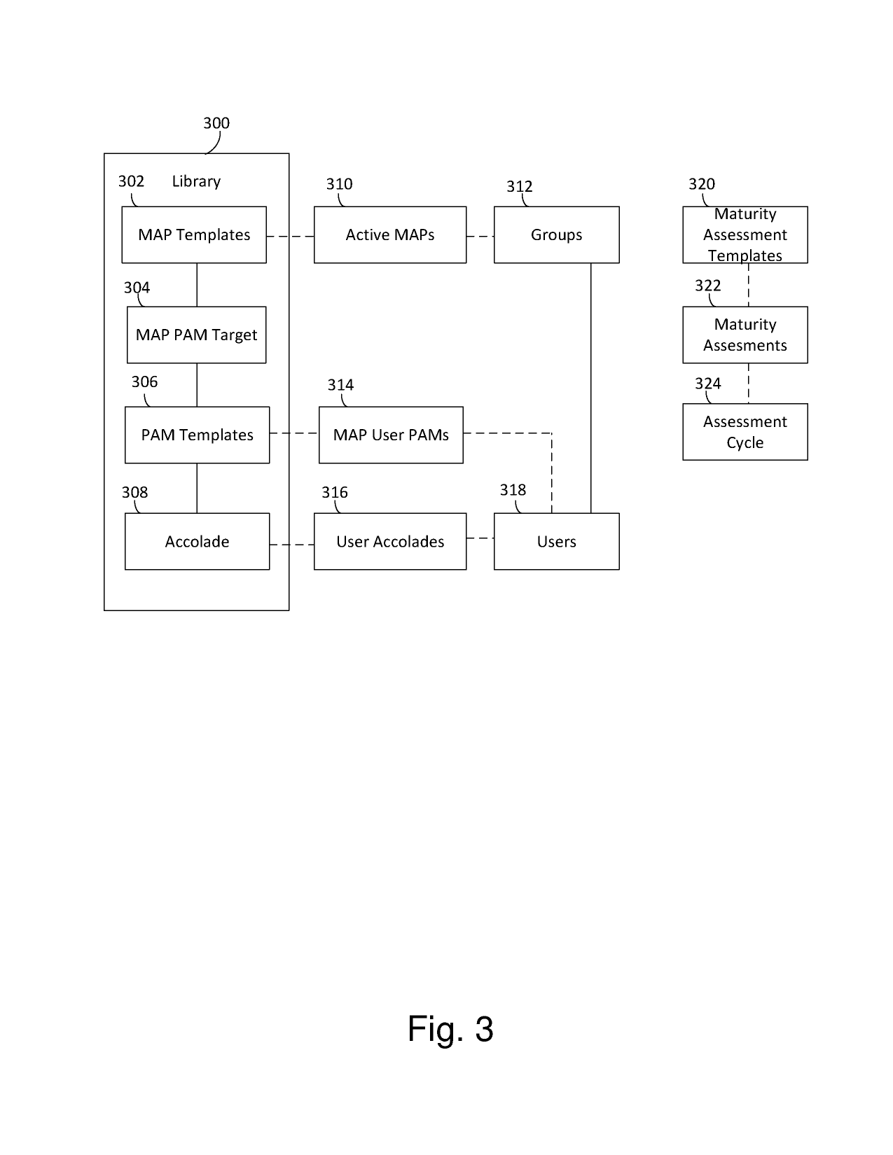

Components of the system as shown in FIG. 3. The library of MAPS 300 includes templates 302, targets 304 accelerators 306 and accolades 308. The user is presented with the active MAP at 310. The active MAP is designed to provide groups and semilir items to the user and to others at 312. PAMs are assigned to users according to MAPs at 314. User accolades are provided to the user at 316. MAPs and accolades are provided to users at 318. The initial assessment process includes using a template 320, assessment 322 implemented during the feedback cycle 324.

The system recites specific technical implementations involving concrete data structures, memory operations, and automated platform reconfiguration mechanisms. The system requires storing organizational development data in a three-level hierarchical structure within computer memory, with each level representing different granularities of organizational progress. The system must automatically navigate through this hierarchical structure using traversal algorithms to determine completion states at multiple levels. The system further requires modifying access control data structures to dynamically unlock platform features based on organizational progress. Multiple specific technical outputs must be generated, including visual dashboards displayed to users, notification data transmitted to remote devices, modified user interface configurations sent to client devices for rendering, comparison reports analyzing organizational progress against benchmark data, and artificial intelligence-generated recommendations based on data structure analysis. These concrete technical operations on memory-stored data structures, combined with automated traversal algorithms, access control modifications, and generation of multiple technical outputs, constitute practical, tangible items.

The invention provides a practical application by implementing a specific technological solution to the technical problem of software platform configuration and reconfiguration without requiring manual software development cycles. Rather than requiring developers to manually write code, reconfigure software settings, or deploy new software versions when organizational needs evolve, the system automatically modifies access control structures in memory and generates modified interface configurations that are transmitted to client devices for rendering. This practical application solves the real-world technical problem of aligning software platform capabilities with evolving organizational needs through automated platform reconfiguration based on data structure state. The system captures anonymized benchmark metadata including completion times, participant counts, and achievement rates, then generates comparison reports that provide practical cross-organizational analysis tools. The automatic navigation through the hierarchical data structure to determine completion status at multiple levels and trigger corresponding platform reconfigurations represents a practical technological implementation that eliminates manual software configuration processes. The generation and transmission of notification data to user devices upon completion events provides practical real-time communication of system state changes. The generation of AI-driven recommendations based on analysis of the data structure and benchmark metadata provides practical guidance for future organizational development planning.

The system improves computer system functionality by fundamentally changing how software platforms adapt their functionality in response to user progress and organizational maturity. The system eliminates manual software reconfiguration by automatically modifying platform functionality based on data structure traversal operations. This represents a significant improvement in computer system operation.Rather than requiring system administrators or developers to manually reconfigure software settings, modify access permissions, or deploy new code when organizational capabilities advance, the computer system automatically modifies access control structures in memory based on the state of the hierarchical data structure. The specific technical architecture of storing a three-level hierarchical structure with defined parent-child relationships and automatically traversing this structure to determine completion states at multiple levels represents an improvement in data structure utilization for dynamic system configuration. The integration of monitoring user interactions, detecting completion events through tracking specific actions, automatically traversing the hierarchical structure upward through multiple levels, comparing completion states against defined thresholds, modifying access control structures, generating modified interface configurations, and transmitting these configurations to client devices represents a technological advancement in adaptive software platform architecture. The computer system's ability to generate multiple technical outputs including visual dashboards, notification data, modified interface configurations, comparison reports, and AI recommendations based on the hierarchical structure state represents an improvement in how computer systems provide integrated feedback and configuration management.

The invention advances the enterprise software industry by providing a technological solution to the longstanding problem of software platform misalignment with organizational maturity, user competencies, and evolving business needs. Traditional enterprise software platforms suffer from static configuration models that require expensive custom development, manual reconfiguration by technical personnel, or complete software replacement as organizations evolve and user capabilities advance. This creates significant technical debt, implementation costs, and periods of misalignment between software capabilities and organizational needs. This invention provides technological improvements by enabling software platforms to automatically reconfigure themselves based on organizational progress tracked through a hierarchical data structure, eliminating the need for traditional software development cycles for platform adaptation. The capture of anonymized benchmark metadata and generation of cross-organizational comparison reports represents a technological advancement in enterprise software analytics, enabling data-driven insights that were previously unavailable. The automatic generation and transmission of modified interface configurations to client devices based on hierarchical structure traversal represents an improvement over static software deployment models that require manual updates or new software releases. The integration of AI-driven recommendations generated from analysis of both the hierarchical structure and benchmark metadata represents a technological advancement in intelligent enterprise software systems that can predict and suggest optimal development paths. The industry improvement extends to reducing the total cost of ownership for enterprise software by eliminating recurring reconfiguration costs, reducing implementation timelines through automated adaptation, and improving alignment between software capabilities and organizational needs through continuous automated adjustment rather than periodic manual intervention.

According to one embodiment, the processes, techniques and functionality described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the processes, techniques and functionality, or may include one or more general purpose hardware processors configured, adapted and programmed to perform the processes, techniques and functionality pursuant to program instructions, such as computer readable instructions, in firmware, memory, other storage, or a combination. Such special-purpose computing devices may also combine custom hard-wired logic, ASICs, or FPGAs with custom programming to accomplish the processes, techniques and functionality. The special-purpose computing devices may be desktop computer systems, portable computer systems, handheld devices, networking devices or any other device that incorporates hard-wired and/or program logic to implement the processes, techniques and functionality.

One or more different inventions may be described in the present application. Further, for one or more of the invention(s) described herein, numerous embodiments may be described in this patent application, and are presented for illustrative purposes only. The embodiments described are not intended to be limiting in any sense. One or more of the invention(s) may be widely applicable to numerous embodiments, as is readily apparent from the disclosure. These embodiments are described in sufficient detail to enable those skilled in the art to practice one or more of the invention(s), and it is to be understood that other embodiments may be utilized and that structural, logical, software, electrical and other changes may be made without departing from the scope of the one or more of the invention(s). Accordingly, those skilled in the art will recognize that the one or more of the invention(s) may be practiced with various modifications and alterations. Particular features of one or more of the invention(s) may be described with reference to one or more particular embodiments or figures that form a part of the present disclosure, and in which are shown, by way of illustration, specific embodiments of one or more of the invention(s). It should be understood, however, that such features are not limited to usage in the one or more particular embodiments or figures with reference to which they are described. The present disclosure is neither a literal description of all embodiments of one or more of the invention(s) nor a listing of features of one or more of the invention(s) that must be present in all embodiments.

Headings of sections provided in this patent application and the title of this patent application are for convenience only, and are not to be taken as limiting the disclosure in any way.

It is understood that the above descriptions and illustrations are intended to be illustrative and not restrictive. It is to be understood that changes and variations may be made without departing from the spirit or scope of the following claims. Other embodiments as well as many applications besides the examples provided will be apparent to those of skill in the art upon reading the above description. The scope of the invention should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. The omission in the following claims of any aspect of subject matter that is disclosed herein is not a disclaimer of such subject matter, nor should it be regarded that the inventor did not consider such subject matter to be part of the disclosed inventive subject matter.

What is claimed is:

1. A computer system adapted to provide organizational maturity and competency development comprising:
a processor in electronic communication with a memory and a display;
a set of computer-readable instructions stored in the memory that, when executed by the processor, cause the system to:
receive a dataset concerning an aspiration associated with an organizational goal;
generate a maturity acceleration plan (MAP) according to the dataset, the MAP comprising a collection of maturity metrics applicable to an individual, a team, a department, an organization and any combination thereof;
generate a performance acceleration model (PAM) according to the MAP, including a collection of measurement criteria representing the ability to demonstrate knowledge, competence, proficiency in a specified area and any combination thereof;
electronically store a hierarchical data structure comprising the MAP at a first level, the PAM at a second level subordinate to the MAP, and an accolade at a third level subordinate to the PAM, wherein the accolade represents an individual measurement of progress;
monitor an user interaction to detect completion of the accolade by tracking at least one of: completion of a training course, usage of a platform feature, creation of a data element, enrichment of data to a specified complexity level, and performance of a specified action; and
display a visual dashboard representing an organizational maturity progress, deployed MAPs, and completed PAM.

2. The computer system of claim 1, wherein the computer readable instructions adapt the system to generate notification data and transmit the notification data to a user device upon completion of the accolade, PAM, or MAP.

3. The computer system of claim 1, wherein the computer readable instructions adapt the system to, upon detecting completion of an accolade, automatically traverse the hierarchical data structure to determine whether completion of the accolade results in completion of an associated PAM by comparing the completed accolade against measurement criteria for the PAM.

4. The computer system of claim 1, wherein the system is adapted to, upon determining completion of a PAM, automatically traverse the hierarchical data structure to determine whether completion of the PAM results in completion of the MAP by comparing completed PAM against a completion threshold defined for the MAP.

5. The computer system of claim 1, wherein the system is adapted to automatically reconfigure the system by modifying access control data structures in the memory to unlock additional platform features based on achieving the completion threshold for the MAP and wherein the system eliminates manual software reconfiguration by automatically modifying platform functionality based on the hierarchical data structure traversal.

6. The computer system of claim 5, wherein the system is adapted to generate a modified user interface configuration that reflects the unlocked platform features and transmit the modified user interface configuration to a client device for rendering.

7. The computer system of claim 6, wherein the system is adapted to generate an artificial intelligence-driven recommendation for a future MAP based on analysis of the hierarchical data structure and a benchmark metadata.

8. The computer system of claim 7, wherein an artificial intelligence algorithm employs machine learning techniques to analyze user interaction data as training data and generate predictive insights for future organizational development plans.

9. The computer system of claim 1, wherein the accolades include one of: completion of a specific training course, usage of a specific platform feature, creation of a specific data element, enrichment of data to a specified complexity level, consistent performance of a specified action over time and any combination thereof.

10. The computer system of claim 1, wherein the system is adapted to deploy the maturity acceleration plan to a selected group of users within the organization based on at least one of department, team, role, or organizational unit.

11. The computer system of claim 10, wherein the system is adapted to assign performance acceleration models to individual users within the selected group using an artificial intelligence analysis of previous user interactions.

12. The computer system of claim 1, wherein the system is adapted to capture anonymized benchmark metadata upon completion of a maturity acceleration plan and utilize the metadata for comparisons with other organizations' progress.

13. The computer system of claim 1, wherein the system is adapted to
automatically reconfigure the system by modifying access control data structures in the memory to unlock additional features based on achieving the completion threshold for the MAP, wherein the unlocked features include new data processing functionalities, new user interface elements, new workflow capabilities and any combination thereof;
capture anonymized benchmark metadata comprising completion time, number of participants, and target achievement rates upon MAP completion, and store the metadata in a benchmark database for cross-organizational comparison; and,
wherein the system eliminates manual software reconfiguration by automatically modifying system functionality based on the hierarchical data structure traversal.

14. A computer system for organizational development, comprising:
a computer device having a digital memory adapted to:
receive organizational data representing organizational goals;
generate a maturity plan based on the organizational data, wherein the maturity plans includes a collection of maturity metrics applicable to at least one of an individual, a team, a department, or an entire organization;
generate performance models for individuals based on the maturity plans, each performance model comprising a collection of measurement criteria representing an individual's ability to demonstrate knowledge, competence, and proficiency in a specified area;
electronically store a hierarchical data structure comprising the maturity plans at a first level, a plurality of performance models at a second level subordinate to the maturity plans, and a plurality of completion metrics at a third level subordinate to each performance model;
monitor user interactions with the system to detect completion of the completion metrics by tracking at least one of: completion of a training course, usage of a platform feature, creation of a data element, enrichment of data to a specified complexity level, and performance of a specified action;
automatically adapt system configuration by modifying access control data structures in the digital memory to unlock system features based on achieving the completion threshold for the maturity plan;
display a visual dashboard showing organizational development progress, deployed maturity plans, and completed performance models; and,
wherein the system eliminates manual software reconfiguration by automatically modifying platform functionality based on the hierarchical data structure traversal.

15. The computer system of claim 14, wherein the computer device is adapted to upon detecting completion of a completion metric, automatically traverse the hierarchical data structure to determine whether completion of the completion metric results in completion of an associated performance model.

16. The computer system of claim 14, wherein the maturity plan includes a maturity acceleration plan (MAP) that include collections of maturity metrics applicable to at least one of an individual, a team, a department, or an entire organization.

17. The computer system of claim 14, wherein the performance model includes a performance acceleration models (PAM) that include collections of measurement criteria representing an individual's ability to demonstrate knowledge, competence, and proficiency in a specified area.

18. The computer system of claim 14, wherein the computer system is adapted to upon determining completion of a performance model, automatically traverse the hierarchical data structure to determine whether completion of the performance model results in completion of a maturity plan by comparing completed performance models against a completion threshold defined for the maturity plan.

19. The computer system of claim 14, wherein the system is configured to generate notification data and transmit the notification data to a user device upon completion of completion metrics, performance models, or maturity plans.

20. A computer system for organizational management, comprising:
a computerized system having a memory and adapted to
receive organizational data representing organizational objectives;
generate organizational development plans comprising hierarchical maturity acceleration structures;
electronically store the hierarchical maturity acceleration structures in the memory;
monitor user progress by tracking user interactions with the system and detecting completion of achievement indicators through monitoring at least one of: training completion events, feature usage events, data creation events, data enrichment operations, and repeated action performance;
automatically configure system functionality by modifying access control data structures stored in the memory to unlock platform capabilities based on achieving the completion threshold for the maturity metric, wherein the unlocked platform capabilities comprise at least one of: data processing functionalities, user interface elements, and workflow capabilities;
provide feature access by granting users access to the unlocked platform capabilities through the modified access control data structures; and,
wherein the system eliminates manual software reconfiguration by automatically modifying platform functionality based on traversal of the hierarchical maturity acceleration structures.
